(19) United States
(12) Patent Application Publication
(10) Pub. No.: US 2021/0173252 A1
(43) Pub. Date: Jun. 10, 2021

(54) DISPLAY SUBSTRATE, LIQUID CRYSTAL DISPLAY PANEL, LIQUID CRYSTAL DISPLAY APPARATUS, AND METHOD OF OPERATING LIQUID CRYSTAL DISPLAY APPARATUS

(71) Applicants: BOE TECHNOLOGY GROUP CO., LTD., Beijing (CN); Hefei Xinsheng Optoelectronics Technology Co., Ltd., Hefei, Anhui (CN)

(72) Inventor: Liangliang Jiang, Beijing (CN)

(73) Assignees: BOE TECHNOLOGY GROUP CO., LTD., Beijing (CN); Hefei Xinsheng Optoelectronics Technology Co., Ltd., Hefei, Anhui (CN)

(21) Appl. No.: 15/777,581

(22) PCT Filed: May 8, 2017
(86) PCT No.: PCT/CN2017/083442

§ 371 Date: May 18, 2018

(51) Int. Cl. G02F 1/1333; G02F 1/13357; G02F 1/1335

(52) U.S. Cl. CPC G02F 1/133382; G02F 1/133624; G02F 1/133602

(57) ABSTRACT

The present application discloses a liquid crystal display panel having an array substrate and a counter substrate. The liquid crystal display panel includes a liquid crystal layer having liquid crystal molecules between the array substrate and the counter substrate; and a light-to-heat-conversion layer having a light-to-heat-conversion material. The light-to-heat-conversion layer is configured to absorb an invisible-light radiation and convert the invisible-light radiation to heat for heating the liquid crystal layer.

### TECHNICAL FIELD

The present invention relates to display technology, more particularly, to a display substrate, a liquid crystal display panel, a liquid crystal display apparatus, and a method of operating a liquid crystal display apparatus.

### BACKGROUND

A liquid crystal display apparatus includes an array substrate and a color filter substrate assembled together, and a liquid crystal layer between the array substrate and the color filter substrate. The liquid crystal layer includes liquid crystal molecules. A liquid crystal display device produces an image by applying an electric field to a liquid crystal layer between the array substrate and the color filter substrate. In response to the electric field applied to the liquid crystal layer, the liquid crystal molecules in the liquid crystal layer rotate. Thus, the electric field changes an alignment direction of the liquid crystal molecules in the liquid crystal layer. Light transmittance of the liquid crystal layer is adjusted when the alignment direction of the liquid crystal molecules changes.

### SUMMARY

In one aspect, the present invention provides a liquid crystal display panel having an array substrate and a counter substrate, comprising a liquid crystal layer comprising liquid crystal molecules between the array substrate and the counter substrate; and a light-to-heat-conversion layer comprising a light-to-heat-conversion material, the light-to-heat-conversion layer being configured to absorb an invisible-light radiation and convert the invisible-light radiation to heat for heating the liquid crystal layer.

Optionally, the light-to-heat-conversion layer is configured to maintain the liquid crystal molecules at a temperature above a threshold value.

Optionally, the light-to-heat-conversion layer is in contact with the liquid crystal molecules in the liquid crystal layer.

Optionally, the light-to-heat-conversion layer is configured to absorb an infrared light radiation and convert the infrared light radiation to heat.

Optionally, the light-to-heat-conversion layer is configured to absorb a near infrared light radiation and convert the near infrared light radiation to heat.

Optionally, the near infrared light radiation has a wavelength in a range of approximately 800 nm to approximately 1000 nm.

Optionally, the light-to-heat-conversion layer is a passivation layer comprising a plurality of particles, each of the plurality of particles comprising the light-to-heat-conversion material.

Optionally, the light-to-heat-conversion layer consists essentially of the light-to-heat-conversion material.

Optionally, the light-to-heat-conversion layer is in the array substrate.

Optionally, the light-to-heat-conversion layer is in the counter substrate.

Optionally, the liquid crystal display panel comprises first light-to-heat-conversion layer is in the array substrate and a second light-to-heat-conversion layer is in the counter substrate; wherein each of the first light-to-heat-conversion layer and the second light-to-heat-conversion layer comprises a light-to-heat-conversion material; and each of the first light-to-heat-conversion layer and the second light-to-heat-conversion layer is configured to absorb the invisible-light radiation and convert the invisible-light radiation to heat.

Optionally, the light-to-heat-conversion material is selected from the group consisting of an infrared ray-absorbing dye, a carbon-containing material, a metal particle, and a metal oxide particle.

Optionally, the light-to-heat-conversion material is selected from the group consisting of gold particles, copper particles, silver particles, tungsten oxide (WO₃₋ₓ), carbon nanotubes, and asymmetrical phthalocyanine.

In another aspect, the present invention provides a liquid crystal display apparatus, comprising the liquid crystal display panel described herein; and an invisible-light light source configured to provide the invisible-light radiation to the light-to-heat-conversion layer.

Optionally, the liquid crystal display apparatus further comprises a backlight module; wherein the invisible-light light source is in the backlight module.

Optionally, the liquid crystal display apparatus further comprises a control circuit connected to the invisible-light light source; wherein the control circuit is configured to maintain the liquid crystal molecules at a temperature above a first threshold value.

Optionally, the control circuit comprises a temperature sensor configured to detect an ambient temperature; and the control circuit is configured to turn on the invisible-light light source provided that the ambient temperature is below a second threshold value.

Optionally, the control circuit is configured to turn off the invisible-light light source provided that the ambient temperature is equal to or greater than the second threshold value.

In another aspect, the present invention provides a display substrate, comprising a light-to-heat-conversion layer comprising a light-to-heat-conversion material, the light-to-heat-conversion layer being configured to absorb an invisible-light radiation and convert the invisible-light radiation to heat for heating the liquid crystal layer.

In another aspect, the present invention provides a method of operating a liquid crystal display apparatus, comprising detecting an ambient temperature; turning on an invisible-light light source to provide invisible-light radiation in the liquid crystal display apparatus when the ambient temperature is below a threshold value; and heating liquid crystal molecules in a liquid crystal layer of the liquid crystal display apparatus by irradiating the invisible-light radiation on a light-to-heat-conversion layer.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a liquid crystal display apparatus in some embodiments according to the present disclosure.

FIG. 2 is a schematic diagram illustrating the structure of a liquid crystal display apparatus in some embodiments according to the present disclosure.

FIG. 3 is a schematic diagram illustrating the structure of a liquid crystal display apparatus in some embodiments according to the present disclosure.

FIGS. 4A to 4D are schematic diagrams illustrating a process of fabricating counter substrate in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Liquid crystal molecules typically has a liquid state and a solid state. When the ambient temperature is below a certain value, e.g., below 0 Celsius degree, liquid crystal molecules become highly viscous. Conventional liquid crystal display panels do not function well at low temperatures because liquid crystal molecules in the liquid crystal layer of the conventional liquid crystal display panels exhibit a very low response rate and an elongated response time due to the high viscosity of liquid crystal molecules at low temperatures, resulting in display defects such as ghosting and trailing. When the ambient temperature is below −25 Celsius degrees, the liquid crystal molecules crystallize, rendering the liquid crystal display panel non-operational.

Accordingly, the present disclosure provides, inter alia, a display substrate, a liquid crystal display panel, a liquid crystal display apparatus, and a method of operating a liquid crystal display apparatus that substantially obviate one or more of the problems due to limitations and disadvantages of the related art. In one aspect, the present disclosure provides a liquid crystal display panel having an array substrate and a counter substrate. In some embodiments, the liquid crystal display panel includes a liquid crystal layer comprising liquid crystal molecules between the array substrate and the counter substrate; and a light-to-heat-conversion layer having a light-to-heat-conversion material, the light-to-heat-conversion layer being configured to absorb an invisible-light radiation and convert the invisible-light radiation to heat for heating the liquid crystal layer.

As used herein, the term “light-to-heat-conversion layer” refers to a layer that is capable of absorbing radiation and converting it to heat. As used herein, the term “light-to-heat-conversion material” refers to a material that is capable of absorbing radiation and converting it to heat.

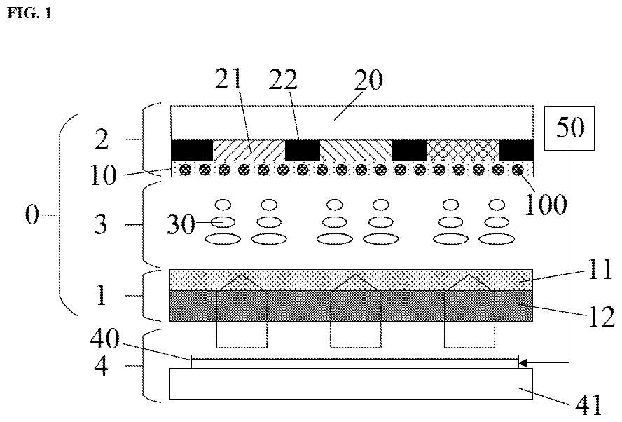

FIG. 1 is a diagram illustrating the structure of a liquid crystal display apparatus in some embodiments according to the present disclosure. Referring to FIG. 1, the liquid crystal display apparatus includes a liquid crystal display panel 0 and a backlight module 4. In some embodiments, the liquid crystal display panel 0 includes an array substrate 1, a counter substrate 2, and a liquid crystal layer 3 between the array substrate 1 and the counter substrate 2. The liquid crystal layer 3 includes liquid crystal molecules 30 configured to transition between a light transmissive state and a light blocking state. The liquid crystal display panel 0 further includes a light-to-heat-conversion layer 10 having a light-to-heat-conversion material. When the light-to-heat-conversion layer 10 is irradiated with light at an absorption wavelength, the light-to-heat-conversion material in the light-to-heat-conversion layer absorbs incident light having a specific wavelength and converts at least part of the incident light into heat. Light-to-heat-conversion materials having various absorption wavelengths may be used in the present light-to-heat-conversion layer 10. Optionally, the light-to-heat-conversion layer 10 is configured to absorb an invisible-light radiation and convert the invisible-light radiation to heat. Optionally, the light-to-heat-conversion layer 10 is configured to absorb a visible-light radiation and convert the invisible-light radiation to heat. Optionally, the light-to-heat-conversion layer 10 is configured to absorb an ultraviolet light radiation and convert the ultraviolet light radiation to heat. Optionally, the light-to-heat-conversion layer 10 is configured to absorb an infrared light radiation and convert the infrared light radiation to heat. Optionally, the light-to-heat-conversion layer 10 is configured to absorb a near infrared light radiation and convert the near infrared light radiation to heat. Optionally, the light-to-heat-conversion layer 10 is configured to absorb a near infrared light radiation having a wavelength in a range of approximately 700 nm to approximately 2500 nm (e.g., approximately 700 nm to approximately 1200 nm, or approximately 800 nm to approximately 1000 nm), and convert the near infrared light radiation to heat.

In some embodiments, the light-to-heat-conversion layer 10 is in the counter substrate 2. Referring to FIG. 1, the counter substrate 2 includes a base substrate 20, a black matrix layer 22 and a color filter layer 21 on the base substrate 20, and the light-to-heat-conversion layer 10 on a side of the black matrix layer 22 and the color filter layer 21 distal to the base substrate 20. Optionally, the light-to-heat-conversion layer 10 is on a side of the counter substrate 2 proximal to the liquid crystal layer 3. Optionally, the light-to-heat-conversion layer 10 is in contact with the liquid crystal molecules 30 in the liquid crystal layer 3. Optionally, the counter substrate 2 further includes one or more layers between the light-to-heat-conversion layer 10 and the liquid crystal layer 3, e.g., the light-to-heat-conversion layer 10 is not in contact with the liquid crystal molecules 30 in the liquid crystal layer 3. Optionally, the light-to-heat-conversion layer 10 is a layer consisting essentially of the light-to-heat-conversion material. Optionally, the counter substrate 2 further includes an overcoat layer between the light-to-heat-conversion layer 10 and the liquid crystal layer 3. As shown in FIG. 1, in one example, the light-to-heat-conversion layer 10 is a passivation layer containing the light-to-heat-conversion material. In another example, the light-to-heat-conversion layer 10 is a passivation layer containing a plurality of particles 100, each of the plurality of particles 100 including the light-to-heat-conversion material.

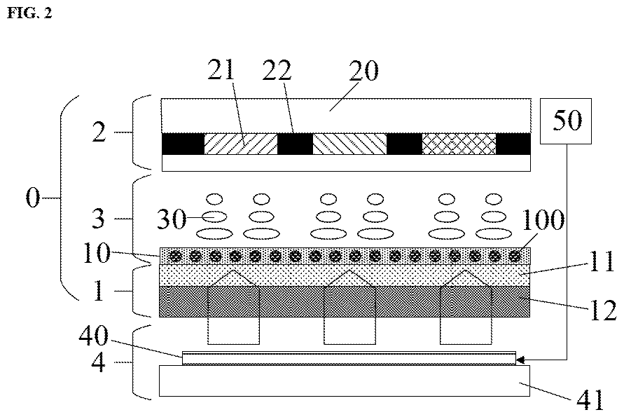

FIG. 2 is a diagram illustrating the structure of a liquid crystal display apparatus in some embodiments according to the present disclosure. Referring to FIG. 2, the light-to-heat-conversion layer 10 in some embodiments is in the array substrate 1. The array substrate 1 includes a base substrate 12, a thin film transistor substrate 11 on the base substrate 12, and a light-to-heat-conversion layer 10 on a side of the thin film transistor substrate 11 distal to the base substrate 12. Optionally, the light-to-heat-conversion layer 10 is on a side of the array substrate 1 proximal to the liquid crystal layer 3. Optionally, the light-to-heat-conversion layer 10 is in contact with the liquid crystal molecules 30 in the liquid crystal layer 3. Optionally, the array substrate 1 further includes one or more layers between the light-to-heat-conversion layer 10 and the liquid crystal layer 3, e.g., the light-to-heat-conversion layer 10 is not in contact with the liquid crystal molecules 30 in the liquid crystal layer 3. Optionally, the light-to-heat-conversion layer 10 is a layer consisting essentially of the light-to-heat-conversion material. Optionally, the array substrate 1 further includes an overcoat layer between the light-to-heat-conversion layer 10 and the liquid crystal layer 3. As shown in FIG. 2, in one example, the light-to-heat-conversion layer 10 is a passivation layer containing the light-to-heat-conversion material. In another example, the light-to-heat-conversion layer 10 is a passivation layer containing a plurality of particles 100, each of the plurality of particles 100 including the light-to-heat-conversion material.

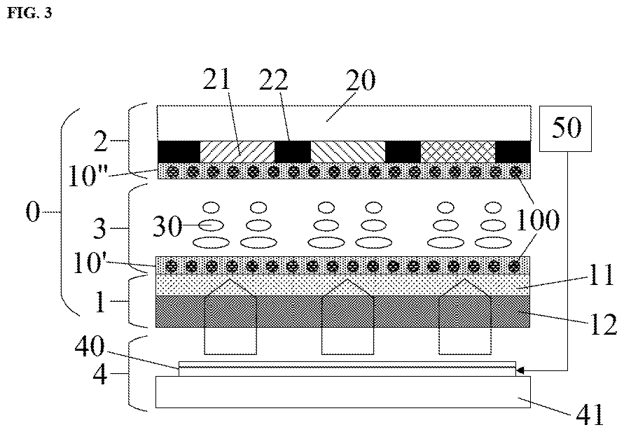

FIG. 3 is a diagram illustrating the structure of a liquid crystal display apparatus in some embodiments according to the present disclosure. Referring to FIG. 3, the liquid crystal display panel 0 in some embodiments includes a first light-to-heat-conversion layer 10′ in the array substrate 1 and a second light-to-heat-conversion layer 10″ in the counter substrate 2. Each of the first light-to-heat-conversion layer 10′ and the second light-to-heat-conversion layer 10″ includes a light-to-heat-conversion material. Each of the first light-to-heat-conversion layer 10′ and the second light-to-heat-conversion layer 10″ is configured to absorb incident light at an absorption wavelength and convert at least part of the incident light to heat. Referring to FIG. 3, the counter substrate 2 includes a base substrate 20, a black matrix layer 22 and a color filter layer 21 on the base substrate 20, and the second light-to-heat-conversion layer 10″ on a side of the black matrix layer 22 and the color filter layer 21 distal to the base substrate 20; and the array substrate 1 includes a base substrate 12, a thin film transistor substrate 11 on the base substrate 12, and the first light-to-heat-conversion layer 10′ on a side of the thin film transistor substrate 11 distal to the base substrate 12. Optionally, the first light-to-heat-conversion layer 10′ is on a side of the array substrate 1 proximal to the liquid crystal layer 3. Optionally, the second light-to-heat-conversion layer 10″ is on a side of the counter substrate 2 proximal to the liquid crystal layer 3. Optionally, each of the first light-to-heat-conversion layer 10′ and the second light-to-heat-conversion layer 10″ is in contact with the liquid crystal molecules 30 in the liquid crystal layer 3. Optionally, each of the first light-to-heat-conversion layer 10′ and the second light-to-heat-conversion layer 10″ is a layer consisting essentially of the light-to-heat-conversion material. As shown in FIG. 3, in one example, each of the first light-to-heat-conversion layer 10′ and the second light-to-heat-conversion layer 10″ is a passivation layer containing the light-to-heat-conversion material. In another example, each of the first light-to-heat-conversion layer 10′ and the second light-to-heat-conversion layer 10″ is a passivation layer containing a plurality of particles 100, each of the plurality of particles 100 including the light-to-heat-conversion material.

Optionally, the light-to-heat-conversion layer extends substantially throughout the counter substrate, or the array substrate, or both. Optionally, a projection of the light-to-heat-conversion layer on a base substrate substantially overlaps with that of the liquid crystal layer. Optionally, a projection of the light-to-heat-conversion layer on a base substrate substantially covers that of the liquid crystal layer.

Various appropriate light-to-heat-conversion materials may be used in the present light-to-heat-conversion layer. In some embodiments, the light-to-heat-conversion material includes one or more compounds selected from the group including an infrared ray-absorbing dye, a carbon-containing material, a metal particle, and a metal oxide particle. Examples of appropriate light-to-heat-conversion materials include, but are not limited to, gold particles, copper particles, silver particles, tungsten oxide (WO₃₋ₓ), carbon nanotubes, and asymmetrical phthalocyanine (e.g., asymmetrical nickel phthalocyanine). Optionally, the light-to-heat-conversion layer includes a light-to-heat-conversion material in a concentration in a range of approximately 5% w/w to approximately 10% w/w.

In some embodiments, the light-to-heat-conversion material is an infrared ray-absorbing dye. Examples of infrared ray-absorbing dyes include, but are not limited to, general organic infrared absorbing dyes, for example, a cyanine dye, a chloconium dye, a polymethine dye, an azulenium dye, a squalenium dye, a thiopyrylium dye, a naphthoquinone dye and an anthraquinone dye; and organometallic complexes, for example, a phthalocyanine compound, a naphthalocyanine compound, an azo compound, a thioamide compound, a dithiol compound and an indoaniline compound. Optionally, the light-to-heat-conversion layer includes an insulating material and an infrared ray-absorbing dye, the infrared ray-absorbing dye evenly distributed in the insulating material. Optionally, the content of the infrared ray-absorbing dye in the light-to-heat-conversion layer is in a range of approximately 0.01% by weight to approximately 50% by weight or more, e.g., approximately 0.1% by weight to approximately 20% by weight, approximately 1% by weight to approximately 10% by weight, and approximately 2% by weight to approximately 5% by weight.

In some embodiments, the light-to-heat-conversion material is a carbon-containing material. Examples of carbon-containing materials include, but are not limited to, particles of carbon black, carbon nano-tubes, and graphite. Optionally, the light-to-heat-conversion material is a particle of a carbon-containing material. Optionally, the diameter of the particle is less than 0.5 μm, e.g., less than 100 nm, or less than 50 nm.

In some embodiments, the light-to-heat-conversion material is a metal. Optionally, the light-to-heat-conversion material includes metal particles, e g., gold particles, copper particles, and silver particles. Optionally, the diameter of the metal particle is less than 0.5 μm, e.g., less than 100 nm, or less than 50 nm. The metal particles may have any appropriate shapes, for example, spherical, flaky and needle-like. Optionally, the metal particles are colloidal metal particles, e.g., colloidal gold particles, colloidal silver particles, and colloidal copper particles.

In some embodiments, the light-to-heat-conversion material is a metal oxide, e.g., tungsten oxide (WO₃₋ₓ) and iron oxide (Fe₃O₄). Optionally, the metal oxide is a complex metal oxide including two or more metal elements, e.g., a Cu—Cr—Mn type metal oxide or a Cu—Fe—Mn type metal oxide. Optionally, the metal oxide includes one or more metal elements selected from the group consisting of tungsten, iron, aluminum, titanium, chromium, manganese, cobalt, nickel, copper, zinc, barium, and antimony. Optionally, the light-to-heat-conversion material includes metal oxide particles. Optionally, the diameter of the metal oxide particle is less than 1.0 μm, e.g., less than 0.5 μm, less than 100 nm, or less than 50 nm.

Optionally, the light-to-heat-conversion material is a substantially transparent material. Optionally, the particles size of the light-to-heat-conversion material is in a range such that a light-to-heat-conversion layer having the particles of the light-to-heat-conversion material is substantially transparent. Optionally, the concentration of the light-to-heat-conversion material in the light-to-heat-conversion layer is in a range such that a light-to-heat-conversion layer having the light-to-heat-conversion material is substantially transparent.

In some embodiments, the light-to-heat-conversion layer is configured to maintain the liquid crystal molecules at a temperature above a threshold value, e.g., 20 Celsius degrees.

In another aspect, the present disclosure further provides a liquid crystal display apparatus. Examples of appropriate liquid crystal display apparatuses include, but are not limited to, an electronic paper, a mobile phone, a tablet computer, a television, a monitor, a notebook computer, a digital album, a GPS, etc.

In some embodiments, the liquid crystal display apparatus includes a liquid crystal display panel described herein, and a light source configured to provide an incident light having a specific wavelength to the light-to-heat-conversion layer for conversion into heat. Optionally, the light source provides an invisible-light radiation to the light-to-heat-conversion layer for conversion into heat. Optionally, the light source provides a visible-light radiation to the light-to-heat-conversion layer for conversion into heat. Optionally, the light source provides an ultraviolet radiation to the light-to-heat-conversion layer for conversion into heat. Optionally, the light source provides an infrared radiation to the light-to-heat-conversion layer for conversion into heat. Optionally, the light source provides a near infrared radiation to the light-to-heat-conversion layer for conversion into heat. Optionally, the light source provides a near infrared radiation having a wavelength in a range of approximately 700 nm to approximately 2500 nm (e.g., approximately 700 nm to approximately 1200 nm, or approximately 800 nm to approximately 1000 nm) to the light-to-heat-conversion layer for conversion into heat.

Referring to FIGS. 1 to 3, the liquid crystal display apparatus in some embodiments includes an invisible-light light source 40 configured to provide an invisible-light radiation to the light-to-heat-conversion layer 10 for conversion into heat. As shown in FIGS. 1-3, the liquid crystal display apparatus in some embodiments includes a backlight module 4, which includes the invisible-light light source 40 and a backlight 41. The backlight 41 is configured to provide light for image display in the liquid crystal display apparatus. The liquid crystal display apparatus in some embodiments further includes a control circuit 50 connected to the invisible-light light source 40. The control circuit 50 is configured to maintain the liquid crystal molecules 30 in the liquid crystal layer 3 at a temperature above a first threshold value.

Optionally, the invisible-light light source 40 is integrated into the backlight 41. For example, the integrated backlight 41 may include a plurality of light bulbs for image display and a plurality of light bulbs for emitting an invisible-light radiation. The plurality of light bulbs for emitting an invisible-light radiation may be evenly distributed in the integrated backlight.

In some embodiments, the control circuit 50 includes a temperature sensor (not shown) configured to detect am ambient temperature. Optionally, the ambient temperature is an external ambient temperature of an operating environment of the liquid crystal display apparatus. Optionally, the ambient temperature is an internal temperature of the liquid crystal display apparatus, e.g., a temperature of the liquid crystal layer 3. The control circuit 50 is configured to turn on the invisible-light light source 40 when the ambient temperature detected is below a second threshold value. Optionally, the control circuit 50 is configured to turn off the invisible-light light source 40 when the ambient temperature detected is equal to or greater than the second threshold value. Optionally, the first threshold value is the same as the second threshold value. In one example, the first threshold value and the second threshold value are both 20 Celsius degrees. In another example, the first threshold value and the second threshold value are both 10 Celsius degrees. Optionally, the first threshold value is different from the second threshold value. In another example, the first threshold value is 20 Celsius degrees and the second threshold value is 10 Celsius degree.

In another aspect, the present disclosure provides a method of operating a liquid crystal display apparatus. In some embodiments, the method includes detecting an ambient temperature; turning on an invisible-light light source to provide invisible-light radiation in the display apparatus when the ambient temperature is below a threshold temperature; and heating liquid crystal molecules in a liquid crystal layer of the display apparatus by irradiating the invisible-light radiation on a light-to-heat-conversion layer. The light-to-heat-conversion layer includes a light-to-heat-conversion material, and is configured to absorb an invisible-light radiation and convert the invisible-light radiation to heat. Optionally, the ambient temperature is an external ambient temperature of an operating environment of the liquid crystal display apparatus. Optionally, the ambient temperature is an internal temperature of the liquid crystal display apparatus, e.g., a temperature of the liquid crystal layer 3. Optionally, the method further includes turning oils the invisible-light light source when the ambient temperature is equal to or greater than the threshold temperature.

In another aspect, the present disclosure provides a display substrate. In some embodiments, the display substrate includes a light-to-heat-conversion layer having a light-to-heat-conversion material. The light-to-heat-conversion layer is configured to absorb an invisible-light radiation and convert the invisible-light radiation to heat. Optionally, the light-to-heat-conversion layer is configured to absorb an ultraviolet light radiation and convert the ultraviolet light radiation to heat. Optionally, the light-to-heat-conversion layer is configured to absorb an infrared light radiation and convert the infrared light radiation to heat. Optionally, the light-to-heat-conversion layer is configured to absorb a near infrared light radiation and convert the near infrared light radiation to heat. Optionally, the light-to-heat-conversion layer is configured to absorb a near infrared light radiation having a wavelength in a range of approximately 700 nm to approximately 2500 nm (e.g., approximately 700 nm to approximately 1200 nm, or approximately 800 nm to approximately 1000 nm), and convert the near infrared light radiation to heat.

In some embodiments, the light-to-heat-conversion layer is a passivation layer having a plurality of particles, each of the plurality of particles including the light-to-heat-conversion material. In some embodiments, the light-to-heat-conversion layer consists essentially of the light-to-heat-conversion material.

Optionally, the display substrate is an array substrate. Optionally, the display substrate is a counter substrate.

In some embodiments, the light-to-heat-conversion material is selected from the group consisting of an infrared ray-absorbing dye, a carbon-containing material, a metal particle, and a metal oxide particle. Optionally, the light-to-heat-conversion material is selected from the group consisting of gold particles, copper particles, silver particles, tungsten oxide (WO₃₋ₓ), carbon nanotubes, and asymmetrical phthalocyanine.

In another aspect, the present disclosure provides a method of fabricating a liquid crystal display apparatus having an array substrate and a counter substrate. In some embodiments, the method includes forming a light-to-heat-conversion layer having a light-to-heat-conversion material. The light-to-heat-conversion layer is formed to absorb an invisible-light radiation and convert the invisible-light radiation to heat. Optionally, the method further includes forming an array substrate; forming a counter substrate facing the array substrate; and forming a liquid crystal layer having liquid crystal molecules between the array substrate and the counter substrate. Upon receiving the invisible-light radiation, the light-to-heat-conversion layer is configured to convert the invisible-light radiation to heat for heating the liquid crystal layer, thereby maintaining the liquid crystal molecules in the liquid crystal layer at a temperature above a threshold value.

Optionally, the light-to-heat-conversion layer is formed to be in contact with the liquid crystal molecules in the liquid crystal layer.

Optionally, the light-to-heat-conversion layer is formed to absorb an invisible-light radiation and convert the invisible-light radiation to heat. Optionally, the light-to-heat-conversion layer is formed to absorb an ultraviolet light radiation and convert the ultraviolet light radiation to heat. Optionally, the light-to-heat-conversion layer is formed to absorb an infrared light radiation and convert the infrared light radiation to heat. Optionally, the light-to-heat-conversion layer is formed to absorb a near infrared light radiation and convert the near infrared light radiation to heat. Optionally, the light-to-heat-conversion layer is formed to absorb a near infrared light radiation having a wavelength in a range of approximately 700 nm to approximately 2500 nm (e.g., approximately 700 nm to approximately 1200 nm, or approximately 800 nm to approximately 1000 nm), and convert the near infrared light radiation to heat.

Optionally, the step of forming the array substrate includes forming the light-to-heat-conversion layer. Optionally, the step of forming the counter substrate includes forming the light-to-heat-conversion layer.

Optionally, the method further includes forming an invisible-light light source configured to provide the invisible-light radiation to the light-to-heat-conversion layer. Optionally, the method further includes forming a backlight module, the invisible-light light source is formed in the backlight module.

Optionally, the method further includes forming a control circuit connected to the invisible-light light source. The control circuit is configured to maintain the liquid crystal molecules at a temperature above a first threshold temperature.

Optionally, the step of forming the control circuit includes forming a temperature sensor configured to detect an ambient temperature. The control circuit is configured to turn on the invisible-light light source provided that the ambient temperature is below a second threshold temperature; and is configured to turn off the invisible-light light source provided that the ambient temperature is equal to or greater than the second threshold temperature.

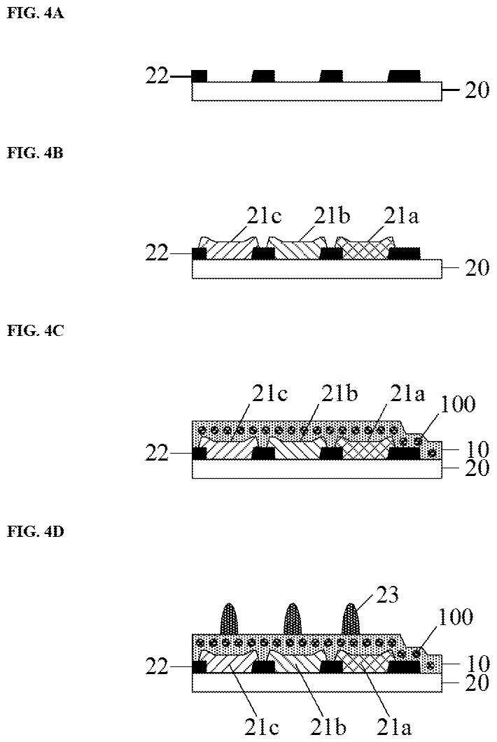

FIGS. 4A to 4D are schematic diagrams illustrating a process of fabricating a counter substrate in some embodiments according to the present disclosure. Referring to FIG. 4A, the step of forming the counter substrate first includes forming a black matrix layer 22 on a base substrate 20. Referring to FIG. 4B, the step of forming the counter substrate further includes forming a first color filter layer 21a, a second color filter layer 21b, and a third color filter layer 21c on the base substrate 20. Referring to FIG. 4C, the step of forming the counter substrate further includes forming a light-to-heat-conversion layer 10 on a side of the black matrix layer 22, the first color filter layer 21a, the second color filter layer 21b, and the third color filter layer 21c distal to the base substrate 20. The light-to-heat-conversion layer 10 is formed using an insulating material having a plurality of particles 100, each of the plurality of particles 100 including a light-to-heat-conversion material. Referring to FIG. 4D, the step of forming the counter substrate further includes forming a plurality of spacers 23 on a side of the light-to-heat-conversion layer 10 distal to the base substrate 20.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A liquid crystal display panel having an array substrate and a counter substrate, comprising:
a liquid crystal layer comprising liquid crystal molecules between the array substrate and the counter substrate; and
a light-to-heat-conversion layer comprising a light-to-heat-conversion material, the light-to-heat-conversion layer being configured to absorb an invisible-light radiation and convert the invisible-light radiation to heat for heating the liquid crystal layer.

2. The liquid crystal display panel of claim 1, wherein the light-to-heat-conversion layer is configured to maintain the liquid crystal molecules at a temperature above a threshold value.

3. The liquid crystal display panel of claim 1, wherein the light-to-heat-conversion layer is in contact with the liquid crystal molecules in the liquid crystal layer.

4. The liquid crystal display panel of claim 1, wherein the light-to-heat-conversion layer is configured to absorb an infrared light radiation and convert the infrared light radiation to heat.

5. The liquid crystal display panel of claim 1, wherein the light-to-heat-conversion layer is configured to absorb a near infrared light radiation and convert the near infrared light radiation to heat.

6. The liquid crystal display panel of claim 5, wherein the near infrared light radiation has a wavelength in a range of approximately 800 nm to approximately 1000 nm.

7. The liquid crystal display panel of claim 1, wherein the light-to-heat-conversion layer is a passivation layer comprising a plurality of particles, each of the plurality of particles comprising the light-to-heat-conversion material.

8. The liquid crystal display panel of claim 1, wherein the light-to-heat-conversion layer consists essentially of the light-to-heat-conversion material.

9. The liquid crystal display panel of claim 1, wherein the light-to-heat-conversion layer is in the array substrate.

10. The liquid crystal display panel of claim 1, wherein the light-to-heat-conversion layer is in the counter substrate.

11. The liquid crystal display panel of claim 1, comprising a first light-to-heat-conversion layer in the array substrate and a second light-to-heat-conversion layer in the counter substrate;
wherein each of the first light-to-heat-conversion layer and the second light-to-heat-conversion layer comprises a light-to-heat-conversion material; and
each of the first light-to-heat-conversion layer and the second light-to-heat-conversion layer is configured to absorb the invisible-light radiation and convert the invisible-light radiation to heat.

12. The liquid crystal display panel of claim 1, wherein the light-to-heat-conversion material is selected from the group consisting of an infrared ray-absorbing dye, a carbon-containing material, a metal particle, and a metal oxide particle.

13. The liquid crystal display panel of claim 12, wherein the light-to-heat-conversion material is selected from the group consisting of gold particles, copper particles, silver particles, tungsten oxide (WO₃₋ₓ), carbon nanotubes, and asymmetrical phthalocyanine.

14. A liquid crystal display apparatus, comprising the liquid crystal display panel of claim 1; and
an invisible-light light source configured to provide the invisible-light radiation to the light-to-heat-conversion layer.

15. The liquid crystal display apparatus of claim 14, further comprising a backlight module;
wherein the invisible-light light source is in the backlight module.

16. The liquid crystal display apparatus of claim 14, further comprising a control circuit connected to the invisible-light light source;
wherein the control circuit is configured to maintain liquid crystal molecules at a temperature above a first threshold value.

17. The liquid crystal display apparatus of claim 16, wherein the control circuit comprises a temperature sensor configured to detect an ambient temperature; and
the control circuit is configured to turn on the invisible-light light source provided that the ambient temperature is below a second threshold value.

18. The liquid crystal display apparatus of claim 17, wherein the control circuit is configured to turn off the invisible-light light source provided that the ambient temperature is equal to or greater than the second threshold value.

19. A display substrate, comprising a light-to-heat-conversion layer comprising a light-to-heat-conversion material, the light-to-heat-conversion layer being configured to absorb an invisible-light radiation and convert the invisible-light radiation to heat for heating a liquid crystal layer.

20. A method of operating a liquid crystal display apparatus, comprising:
detecting an ambient temperature;
turning on an invisible-light light source to provide invisible-light radiation in the liquid crystal display apparatus when the ambient temperature is below a threshold value; and
heating liquid crystal molecules in a liquid crystal layer of the liquid crystal display apparatus by irradiating the invisible-light radiation on a light-to-heat-conversion layer.
